(19) United States
(12) Patent Application Publication
(10) Pub. No.: US 2009/0243173 A1
(43) Pub. Date: Oct. 1, 2009

(54) COMBINATION BEARING WITH BUSH BEARING

(75) Inventors: Wolfgang SCHNAARS, Osnabruck (DE); Ansgar SCHICK, Neuenkirchen-Vorden (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 12/408,830

(22) Filed: Mar. 23, 2009

(30) Foreign Application Priority Data
Mar. 27, 2008 (DE) 10 2008 000 858.3

(51) Int. Cl. F16F 1/38

(52) U.S. Cl. 267/141.2

(57) ABSTRACT

The invention concerns a combination bearing, consisting of a bearing carrier (2) having an eye-shaped recess (3) and a bush bearing (1) designed for press-fit insertion into the eye-shaped recess (3). According to a preferred embodiment, the bush bearing (1) is configured without outer reinforcement for direct installation in the eye-shaped recess (3).

In order to avoid a slipping of the bush bearing (1) that is press-fitted into the eye-shaped recess (3) and the noises connected therewith, it is proposed to provide the inner surface of the eye-shaped recess (3) in one or several of the areas adjacent to the outer contour (6) of the bush bearing (1) formed by the elastomeric bearing body (5) or an outer sleeve that may be present, if applicable, with a profiling (7) running in peripheral direction (u), so that the eye-shaped recess (3) within each area provided with a profiling (7) has an inner diameter (dᵢ, dᵢ′) that alternatively increases or decreases multiple times. The outer contour (6) of the bush bearing is furthermore provided with a corresponding profiling.

This application claims priority from German patent application serial no. 10 2008 000 858.3 filed Mar. 27, 2008.

### FIELD OF THE INVENTION

The invention relates to a combination bearing with an elastomeric bush bearing consisting of a bearing carrier having an eye-shaped recess and the bush bearing designed for press-fit insertion into this eye-shaped recess. According to a preferred embodiment, it relates in particular to an arrangement in which the bush bearing is configured without additional outer reinforcement, that is, without an outer sleeve, for direct installation in the eye-shaped recess of the bearing carrier.

### BACKGROUND OF THE INVENTION

The elastomeric bush bearings corresponding to the bush bearings utilized in the combination according to the invention are used in large numbers above all in vehicle manufacturing. They are used in particular for mounting components of the chassis. The bearings consist in most cases essentially of a predominantly cylindrical-shaped metallic inner part and an elastomeric bearing body connected thereto by vulcanization, by means of which a bearing spring is formed. Depending on the intended use and specification, the rubber-metal part formed in this way is additionally accommodated in an outer sleeve acting as a reinforcement, which is made of metal or plastic. Models that are not equipped, however, with an outer sleeve and are configured for direct installation in the eye-shaped recess of a bearing carrier are also in use. Two or more chambers connected to each other by means of a channel for the purpose of accommodating a liquid damping medium can also be arranged in its elastomeric bearing body, likewise depending on the intended use of the bearing.

Bearings configured in this way for use in the area of the chassis suspension in a motor vehicle are pressed into the eye-shaped recess of the bearing carrier, which connects different elements of the chassis to each other. The bearings are exposed during use to strong torsional stress, among other things. Despite the press fit provided between the outer contour of the elastomeric bush bearing and the inner contour of the eye-shaped recess and the positive engagement established thereby, slipping of the rubber bearing within the eye-shaped recess occurs on some occasions at large torsion angles. Noises, which are perceived as unpleasant, are produced as a consequence of this.

While slipping of the elastomeric bearing in combination bearings with metallic bearing carrier and bush bearing without outer sleeve can generally only be observed at torsion angles of more than 20°, corresponding events are already noticed with small torsion angles in arrangements in which the bearing carrier is made of plastic. On the other hand, there is a tendency to making the corresponding parts of plastic, and thus, if applicable, also the bearing carrier, in particular due to reasons of weight reduction. The slipping of an elastomeric bearing accommodated in the eye-shaped recess is disadvantageously favored by the smooth surface of the inner contour of the eye-shaped recess of a bearing carrier made of plastic.

### SUMMARY OF THE INVENTION

It is the object of the invention to prevent the aforementioned disadvantages and make available a combination bearing, by means of which slipping of an elastomeric bearing accommodated in the eye-shaped recess of a bearing carrier is reduced or prevented to a great extent.

The object is attained by means of a combination bearing having the features of a bearing carrier and an elastomeric bush bearing accommodated therein.

The combination bearing proposed for the purpose of attaining the object of the invention consists, as already explained, of a bearing carrier and a bush bearing, wherein an eye-shaped recess is provided in the bearing carrier in which the elastomeric bush bearing is press-fit inserted. The bush bearing consists, as is known from the state of the art, of at least one metallic, preferably cylindrically-shaped, inner part and an elastomeric bearing body that encloses the inner part and is connected thereto by vulcanization, which forms a bearing spring.

According to the invention, the eye-shaped recess of the bearing carrier is configured in such a way, that its inner surface, which comes in contact with the outer contour of the bush bearing after the latter is press fitted, has one or several areas exhibiting a profile running in the peripheral direction of the bearing. The profiling of the inner surface of the eye-shaped recess is accordingly such, that the eye-shaped recess of each area provided with a profiling has an inner diameter that alternatively increases or decreases multiple times. According to the invention, the bush bearing also has corresponding profiling on its outer contour that faces toward the inner surface of the eye-shaped recess. This means that the bush bearing has respectively one complementary profiling on its outer contour corresponding with the area or areas of the inner surface of the eye-shaped recess provided with the profiling. The bush bearing has accordingly outer diameters that alternatively increase or decrease multiple times in the correspondingly profiled areas of its outer contour.

Since the invention comprises a combination bearing with a bush bearing without an outer sleeve as well as also one with an outer sleeve, the correspondingly (at least in some areas) profiled outer contour of the bush bearing is formed either by means of the elastomer of the bearing body or an outer sleeve made of metal or plastic that encloses the latter, if applicable, wherein the former is achieved, for example, by using corresponding molds during vulcanization.

With regard to the generally thin wall thickness of the outer sleeve of bush bearings of this kind in the last mentioned case, not only the outer surface of the outer sleeve, but the outer sleeve as such is similarly profiled according to an embodiment relevant for the practice. This means that its outer surface facing away from the bearing body and the outer surface facing toward it are completely parallel to each other.

Different possibilities are available for the configuration and arrangement of the profiled areas. To these belong embodiments in which each of the profiled areas extends over the entire axial length of the outer contour of the bush bearing or the inner surface of the eye-shaped recess of the bearing carrier. As long as the outer contour of the bearing and the eye-shaped recess have different axial lengths (the bearing projects, for example, in an axial direction out of the eye-shaped recess or its outer contour is exceeded in axial direction by the eye-shaped recess), this includes the possibility that even though the affected profiled areas extend over the entire length of the inner surface of the eye-shaped recess but not over the entire length of the outer contour of the bearing, they preferably extend over the entire axial length covered by the eye-shaped recess or vice versa. Embodiments in which each profiled area extends over the entire periphery of the outer contour of the bush bearing or the inner surface of the eye-shaped recess also belong to these. In a particularly preferred embodiment of the combination bearing according to the invention, the outer contour of the corresponding bush bearing or the inner surface of the eye-shaped recess has only one profiled area which extends over the entire axial length and over the entire periphery of the bush bearing and/or the eye-shaped recess respectively. The outer contour of the bush bearing or the inner surface of the eye-shaped recess preferably has an undulated contour in the profiled area or areas.

The profiling of the outer contour of the bush bearing according to the invention in a peripheral direction and the consequently corresponding profiling of the eye-shaped recess reliably prevent slipping of the bush bearing in the eye-shaped recess also, if the combination bearing is subjected to high torsional stress. This applies even if the inner surface of the eye-shaped recess has a relatively smooth surface due to its material composition. With regard to the desired reduction of mass of several assemblies, in particular in automotive engineering, the bearing carrier is accordingly made of plastic in a possible embodiment of the combination bearing according to the invention. A corresponding embodiment is considered, for example, for a coupling rod serving as bearing carrier, which connects a stabilizer to the corresponding strut of a vehicle axle in the area of the chassis suspension.

### BRIEF DESCRIPTION OF THE DRAWINGS

The invention will be described again in more detail in the following on the basis of an exemplary embodiment. Shown in the drawings:

FIG. 1: a possible embodiment of the elastomeric bush bearing of the combination bearing, and

FIG. 2: a bearing carrier for accommodating two elastomeric bush bearings according to FIG. 1.

### DETAILED DESCRIPTION OF THE PREFERRED EMBODIMENTS

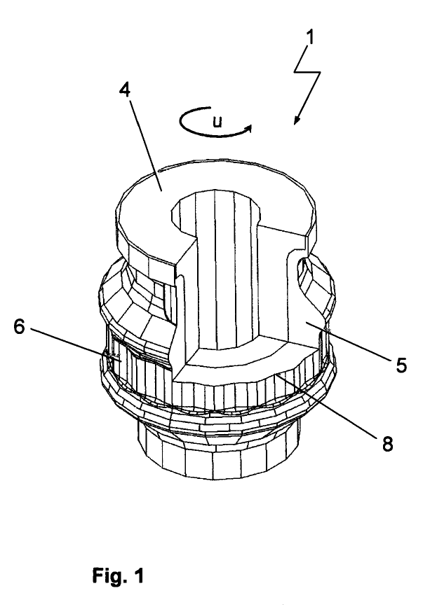

FIG. 1 shows a spatial representation of a possible embodiment of an elastomeric bush bearing 1 of the combination bearing 1, 2 according to the invention, wherein the bush bearing 1 is drawn with an imaginary portion cut off for better illustration in the representation. The bush bearing 1 consists of the metallic inner part 4 which is cylindrically-shaped in the example and the bearing body 5 which concentrically encloses the inner part 4. The bearing body 5, which forms a bearing spring, is adhesively connected by vulcanization to the inner part 4. The bush bearing shown in the example is configured without reinforcing outer sleeve.

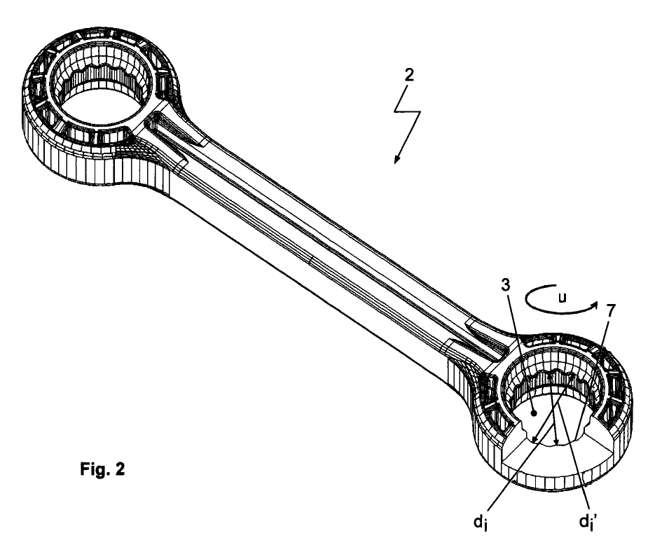

The bush bearing 1 is configured to be pressed into a bearing carrier 2, such as the one shown as an example in FIG. 2. Differing from the state of the art, the outer contour 6 of the bush bearing 1 does not have an even outer surface, but is provided with a profiling 8. As can be seen in the figure, the profiling 8 is such that the outer contour 6 has an undulating characteristic with reference to the peripheral direction u of the bearing. The profiling 8 extends about the entire outer contour 6 of the bush bearing 1 with reference to the length in axial direction r as well as also with regard to the peripheral direction u.

FIG. 2 shows as an example a bearing carrier 2 which is designed for accommodating two bush bearings 1 like the one shown in FIG. 1, wherein the respective bearing is pressed for this purpose into an eye-shaped recess 3 of the bearing carrier 2. A press fit between the respective elastomeric bush bearing 1 and the bearing carrier 2 is thus produced. In FIG. 2 it can be seen, that the inner contour of the respective eye-shaped recess 3 of the bearing carrier 2 designed for accommodating the bush bearing 1 is provided with a profiling 7 corresponding with the outer contour 6 of the elastomeric bush bearing 1, that is, corresponding with the outer surface of the bearing body 5 with reference to the example. Accordingly, the inner surface of the eye-shaped recess 3 likewise has an undulating characteristic with reference to the peripheral direction u. This profiling 7 provides the eye-shaped recess 3 consequently with an alternatively decreasing inner diameter dᵢ and an increasing inner diameter dᵢ′. Slipping of the bush bearing 1 in the eye-shaped recess 3 is securely prevented also in the presence of high torsional stress by means of the engagement with each other of the profiled surface contour of the eye-shaped recess 3 and the bush bearing 1, when the bush bearing 1 is pressed into the bearing carrier 2 or into its eye-shaped recess 3. An increased comfort with reference to the use in automotive engineering is achieved in this way, since the disruptive noises connected with an eventual slipping of the bush bearing 1 in the eye-shaped recess 3 are avoided.

The bearing carrier 2 shown in FIG. 2 is a coupling rod which is provided for installation in the chassis suspension and connects herein a stabilizer to the corresponding strut of a vehicle axle, wherein the coupling is carried out via the bush bearing 2 to be pressed into the ends of the bearing carrier 2 according to the embodiment shown in FIG. 1.

### LIST OF REFERENCE CHARACTERS

1 Bush bearing
2 Bearing carrier
3 Eye-shaped recess
4 Inner part
5 Bearing body
6 Outer contour
7 Profiling
8 Profiling
u Peripheral direction

1-10. (canceled)

11. A combination bearing (1, 2) comprising:
a bearing carrier (2) having at least one eye-shaped recess (3) and an elastomeric bush bearing (1) which is designed for press-fit insertion into the at least one eye-shaped recess (3),
the bush bearing (1) having an outer contour (6) and comprising at least one metallic inner part (4) and an elastomeric bearing body (5) vulcanized thereto to form a bearing spring,
wherein an inner surface of the at least one eye-shaped recess (3) of the bearing carrier (2), which engages with the outer contour (6) of the bush bearing (1) when the bush bearing (1) is inserted into eye-shaped recess (3), has at least one area with a profiling (7) which extends in a peripheral direction of the bush bearing (1) such that the at least one eye-shaped recess (3), within each of the areas provided with the profiling (7), has an inner diameter (dᵢ, dᵢ′) that alternatively increases and decreases multiple times, and the bush bearing (1) has a complimentary profiling (8), on the outer contour (6) facing toward the inner surface of the eye-shaped recess (3), which corresponds with the at least one area of the inner surface of the at least one eye-shaped recess (3) provided with the profiling (7).

12. The combination bearing (1, 2) according to claim 11, wherein the outer contour (6) of the bush bearing (1) is formed by an outer surface of the elastomeric bearing body (5).

13. The combination bearing (1, 2) according to claim 11, wherein the outer contour (6) of the bush bearing (1) is formed of an outer sleeve made of either metal or plastic which encloses the metallic inner part (4) with the bearing body (5).

14. The combination bearing (1, 2) according to claim 13, wherein an outer surface facing away from the bearing body (5) and an outer surface of the outer sleeve facing toward the bearing body (5) are parallel to one another.

15. The combination bearing (1, 2) according to claims 11, wherein each area of the outer contour (6) of the bush bearing (1), which is provided with a profiling (8), extends along an entire length of the outer contour (6) with reference to an axial direction (a) of the bush bearing (1).

16. The combination bearing (1, 2) according to claim 11, wherein each area of the outer contour (6) of the bush bearing (1) which is provided with a profiling (8) extends about an entire periphery of the outer contour (6).

17. The combination bearing (1, 2) according to claim 11, wherein the outer contour (6) of the bush bearing (1) has only one area with a profiling (8) which extends along an entire axial length and over an entire periphery of the outer contour (6).

18. The combination bearing (1, 2) according to claim 11, wherein each cross sectional surface of the bush bearing (1), specified by an imaginary section in radial Direction®, within an area provided with a profiling (8) has an undulating contour (6) in the area provided with a profiling (8).

19. The combination bearing (1, 2) according to claim 11, wherein the bearing carrier (2) is made of plastic.

20. The combination bearing (1, 2) according to claim 11, wherein the bearing carrier (2) is a coupling rod that connects a stabilizer to a corresponding strut of the chassis suspension of a motor vehicle.
